(19) United States
(12) Patent Application Publication
(10) Pub. No.: US 2017/0251707 A1
(43) Pub. Date: Sep. 7, 2017

(54) PROCESS FOR THE PRODUCTION OF LOW COLORIE SWEETENER COMPOSITIONS AND USES THEREOF

(71) Applicant: NATALE VITTORI, COPPELL, TX (US)

(72) Inventor: NATALE VITTORI, COPPELL, TX (US)

(21) Appl. No.: 15/452,607

(22) Filed: Mar. 7, 2017

Related U.S. Application Data
(60) Provisional application No. 62/494,624, filed on Aug. 15, 2016.
(60) Provisional application No. 62/389,704, filed on Mar. 7, 2016.
(60) Provisional application No. 62/392,269, filed on May 25, 2016.

(51) Int. Cl. A23L 27/30; A23L 27/00; A23L 27/10

(52) U.S. Cl. CPC A23L 27/34; A23L 27/33; A23L 27/10; A23L 27/88; A23V 2002/00

(57) ABSTRACT

This invention relates to the production of a powder sweetener composition, having a low glycemic and insulinemic response, with which provides a pleasant, sweet flavor. A unique feature of this sweetener formulation is the ability to edulcorate without much interfering with the flavor of the final product, thus imparting pleasant organoleptic properties when used for the edulcoration of foods. The patent describes a chemical process for its production using specialized equipment such as a high shear plug share horizontal mixer, or a vertical high-speed shear mixer, capable of producing the final product in the form of a granular, free flowing material.

### CLAIM OF PRIORITY

This application claims the benefit of U.S. Provisional Application No. 62/389,704, filed 7 Mar. 2016; U.S. Provisional Application No. 62/392,269, filed 25 May 2016; and U.S. Provisional Application No. 62/494,624, filed 15 Aug. 2016. The information contained therein is hereby incorporated by reference.

### BACKGROUND

1. Field of the Invention

The present application relates to the production of a powder sweetener compositions, having low calorie and low glycemic—insulinemic response, with which provides a pleasant, sweet flavor.

2. Description of Related Art

A high intake of added sugar may contribute to excess energy intake, which leads to overweight conditions and is one of the major factors involved in the development of the metabolic syndrome, thereby increasing the risk of developing type 2 diabetes and cardiovascular diseases. For this reason, a large number of possible sugar substitutes have emerged into the food market in the last decades offering interesting advantages such as low or zero calorie, and far more important, being low glycemic and insulinemic. Erythritol for example is one of them; chemically known as ((2R,3S)-butane-1,2,3,4-tetraol) is a natural sugar alcohol (or polyol) which has been approved for use in the United States and throughout much of the world. It occurs widely in nature in fruits and fermented foods and has been found to occur naturally in several foods such as wine, sake, beer, watermelon, pear, grape, and soy sauce. At an industrial level, Erythritol is produced by fermentation, using glucose as the main carbon source and also from corn or wheat starch by enzymatic hydrolysis yielding glucose which is fermented by safe and suitable food-grade osmophilic yeast, either Moniliella pollinis or Trichosporonoides megachlien-esis. Its edulcurant power is 60-70% as sweet as table sugar, but it has many biological advantages such as: does not induce increases in blood sugar levels, it is almost non-caloric, does not cause tooth decay, is absorbed by the body, and therefore is unlikely to cause gastric side effects, unlike other sugar alcohols, and has an antioxidant property. Under U.S. Food and Drug Administration (FDA) labeling requirements, it has a caloric value of 0.2 kcal/g (95% less than sugar and other carbohydrates), though nutritional labeling varies from country to country, some countries such as Japan label it as zero-calorie, while European Union regulations currently label it and all other sugar alcohols at 2.4 kcal/g.

In the human metabolism, Erythritol is absorbed into the bloodstream in the small intestine and then, for the most part, excreted unchanged in the urine. Because Erythritol is normally absorbed before it enters the large intestine, it does not normally cause laxative effects as are often experienced after over-consumption of other sugar alcohols (such as xylitol and maltitol). For this reason, most people would rather consume Erythritol in virtue of no significant side effects. This is a unique characteristic, as other sugar alcohols are not absorbed directly by the body in this manner and are consequently more prone to causing gastric distress.

However, despite the many biological benefits given by the use of Erythritol as a non-caloric alternative to table sugar, it suffers, as any other similar sugar alcohols, with the disadvantage of producing a cooling sensation upon ingestion. Due to its chemical structure being a four-carbon alcohol, Erythritol has a negative heat of dissolution. This fact presents some disadvantages in relation to its use in confectionary since, in some applications such as candy and chocolate, this cooling effect renders the final products with poor organoleptic properties. In relation to this limitation, US Patent Publication Number 2010/0129517 A1 indicates a procedure for elimination of the cooling effect produced by Erythritol by using polysaccharide gums and the use of sugar esters and/or fibers selected from pectin, guar gum, xanthan gum, locust bean gum, alginate, carrageenan, soluble cocoa fiber, soluble fiber of guar gum, cellulose, cellulose derivatives, beta-glucan, acetylated distarch adipate, n-OSA starch, hydroxypropyl starch phosphate, partially depolymerized fibers and mixtures of two or more thereof to reduce the cooling effect; in particular, the sensory cooling effect of Erythritol. In a similar work, US Publication Number US 2007/0154592 A1 indicates a procedure whereby the suppression of the cooling effect is reached by the incorporation of non-digestible dextrins in ratios which vary from 25 to 75 dextrin/Erythritol. Another interesting low calorie and low glycemic sugar substitute is L-Arabinose, also known chemically as an aldo-pentose, and which is a monosaccharide containing five carbon atoms, including an aldehyde (CHO) functional group. Although most saccharides are almost always more abundant in nature as the “D”-form, L-Arabinose is in fact more common than D-Arabinose in nature and is found in nature as a component of biopolymers such as hemicellulose and pectin.

L-Arabinose is a naturally occurring pentose and is widely distributed as a component of complex non starch polysaccharides in plant cell walls, including maize, wheat, rye, rice, sugar beets, and plant gums. L-Arabinose is one class of natural compounds which is rapidly emerging as one very interesting substance with a wide range of biological activities and very interesting potential nutritional advantages. In vitro studies performed using porcine intestinal mucosa indicated an inhibitory effect of L-Arabinose on intestinal sucrase activity. In vivo studies have been proposed, investigating the effects of L-Arabinose through feeding mice and rats with sucrose and sucrose in combination with L-Arabinose, which resulted in suppressed blood glucose and insulin responses. Furthermore, liver triacylglycerol concentrations increased when the rats were fed with sucrose, but additional feeding of L-Arabinose prevented this increase. In addition, two studies investigating the acute (test meal) and sub chronic (twice a day for 9 week) effects of L-Arabinose after sucrose feeding in rats and pigs showed suppressed blood glucose in both cases. Accordingly, potential nutritional advantages of consuming L-Arabinose in combination with sucrose may be the delayed digestion of sucrose, and consequently a slower absorption of glucose resulting in delayed and decreased blood glucose and insulin responses. Animal studies using chicks, roosters, and pigs as models indicated that the metabolizable energy of L-Arabinose is significantly less than that of D-glucose. Effects on the consumption of L-Arabinose on plasma glucose and insulin response and possible gastrointestinal adverse effects have been studied in human subjects to a very limited degree. This study showed that increases in plasma glucose and serum insulin were reduced in both healthy and type 2 diabetic subjects after consumption of sucrose with 4% added L-Arabinose. These results demonstrate that L-Arabinose attenuates sucrose-induced hyperglycemia both in normal subjects and diabetic patients, presumably through inhibition of intestinal sucrose activity.

Another interesting feature related with the ingestion of L-Arabinose, is its effect on metabolic syndrome. In a study conducted to explore the effects of L-Arabinose in rats with metabolic syndrome induced by a high-carbohydrate, high-fat (HCHF) diet, results suggests that L-Arabinose could lower body weight, lee's index, visceral index, and improve dyslipidemia, insulin resistance, inflammation, and viscera function, thus indicating that it might be a promising candidate for therapies combating metabolic syndrome. To this effect, a very significant study was conducted in order to determine the effects of consumption L-Arabinose on metabolic syndrome in humans. All volunteers received L-Arabinose by dissolving it in water, along with unchanged in the diet habits and lifestyles during the whole experiment. The trial lasted for 6 months, and experimental indicators were assayed every two months, which included weight (TG), waist circumference, total cholesterol (TC), blood pressure, high-density lipoprotein cholesterol (HDLC), low-density lipoprotein cholesterol (LDLC), fasting plasma glucose, serum uric acid, serum creatinine (Scr), blood urea nitrogen (BUN), alanine aminotransferase (ALT) and aspartate aminotransferase (AST). The results from this study showed that the L-Arabinose decreased waist circumference, total cholesterol, fasting glucose, serum uric acid, low-density lipoprotein cholesterol, slightly increased high-density lipoprotein cholesterol, and slightly decreased diastolic blood pressure after six months. The study provides strong evidence that long-term received L-Arabinose would be beneficial in managing human metabolic syndrome.

Another substance which must be included along the same line of possible sugar substitutes, is the non-reducing disaccharide known as Trehalose. This disaccharide has many biotechnological applications, as its physicochemical properties allow it to be used to preserve foods, enzymes, vaccines, cells etc., in a dehydrated state at room temperature. What makes trehalose a good sugar alternative is that the body needs to break down the non-reducing disaccharide Trehalose into glucose throughout the biological action of an enzyme known as Trehalase. This enzyme is found in a very small region in the small intestine and there is a very low finite amount produced by the body. Because it takes a good amount of time for the food that we eat to be digested (it takes about four to eight hours on average for food to pass through your stomach and small intestine) and to be available to reach the small intestine where the enzyme Trehalase is found, then any Trehalose will have been fully mixed with food. For this reason, there is only a small amount entering the small intestine at any time. Therefore, the small amount of Trehalose can produce only a small amount of glucose, which is why the blood plasma testing shows that Trehalose has an almost flat response in terms of influence on blood glucose levels.

A randomized, double-blind, crossover study designed to assess the effects of trehalose, alone and in combination with fructose, on postprandial serum insulin and glucose levels in obese men was designed and compared with a glucose control. The results of this study showed that Trehalose, alone or in combination with fructose, elicited lower glycemic and insulinemic responses in obese men as compared with glucose alone, and may have advantages in the development of food products. Another study revealed that trehalose prevents adipocyte hypertrophy and mitigates insulin resistance in HFD-fed mice by reducing insulin secretion and down-regulating mRNA expression of MCP-1. These findings further suggest that trehalose is a functional saccharide that mitigates insulin resistance. Another interesting study on Trehalose is the effects of pre-exercise ingestion of trehalose, galactose, and glucose on subsequent metabolism and cycling performance. These studies concluded that pre-exercise ingestion of trehalose and galactose resulted in lower plasma glucose and insulin responses prior to exercise and reduced the prevalence of rebound hypoglycemia.

Another interesting sugar alcohol is glycerol, which is an integral part of lipids, having a caloric content of 4.32 kcal/g. In mammalian species, this quantity of calories becomes biologically available through known metabolic pathways common to carbohydrate and fat metabolism. Therefore, under hypocaloric conditions, glycerol can be metabolized to generate energy and conserve body proteins. Although experimental data indicates that blood glycerol concentrations can be depressed by insulin, the insulin response to exogenous glycerol has been found to be small and inconsistent, and appears to be dependent on the route of administration. In human subjects, continuous intravenous administration of glycerol at a dose of 1 g/kg body weight did not result in an increased serum insulin concentration. Glycerol is free from structural alerts, which raises concern for mutagenicity. Glycerol does not induce gene mutations in bacterial strains, chromosomal effects in mammalian cells, or primary DNA damage in vitro. Results of a limited gene mutation test in mammalian cells were of uncertain biological relevance. In vivo, glycerol produced no statistically significant effect in a chromosome aberrations and dominant lethal study. However, the limited details provided and the absence of a positive control prevents any reliable conclusions to be drawn from the in vivo data. Overall, glycerol is not considered to possess genotoxic potential.

In another similar study, in order to determine the effect of glycerin on plasma glucose and insulin responses, 8 healthy subjects (5 male, 3 female; age 27.3±1.7y; BMI 23.9±1.3 kg/m2) were studied on 6 mornings after 10-14 h overnight fasts. They drank 250 ml aqueous solutions containing glycerin (15, 35 or 75 g) or glucose (15 or 75 g) or water alone, with blood samples taken fasting and at ¼, ½, ¾, 1, 2 and 3 h. All test drinks were well tolerated, except, after 75 g glycerol, four subjects experienced mild nausea or headache which resolved by the end of the test session. Oral glucose elicited a significant dose-dependent increase in the incremental areas under the glucose and insulin response curves (AUC). However, after, oral glycerin, plasma glucose, and insulin responses did not differ significantly from those after water alone.

An interesting natural product having a low glycemic index is the Yacón powder fructo-oligosaccharides. Yacón syrup and Yacón powder is a sweetening agent extracted from the tuberous roots of the Yacón plant (Smallanthus sonchifolius) indigenous to the Andes Mountains. New research studies are revealing that the Yacón powder not only has sweetness, but also shows antioxidant effects on multiple classical in vitro free radical assays and especially on different superoxide anion radical generation systems. In a research study using model rats induced diabetic using streptozotocin, Yacón proved to improve oxidative stress. In another similar study, daily consumption of Yacón powder proved to preserve an anti-inflammatory state in phagocytic cells, and improved mucosal immunity, possibly preventing the risks associated with autoimmune and metabolic diseases.

The final natural sweetener which is included and utilized in this patent is natural honey. Despite the fact that honey is rich in sugars, research studies have shown to exert other important biological functions such as scavange reactive oxygen species, ameliorate oxidative stress and even reduce hyperglycemia. Honey, compared with other reducing sugars such as dextrose, sucrose and even other similar sweeteners, was reported to attenuate postprandial glycemic response in non-diabetic volunteers. In healthy human subjects, natural honey produced minimal increments (20%) compared with simulated honey and D-glucose which instead elevated the blood glucose levels by 47% and 52%. The study further showed that after 180 minute, the reduction in blood glucose levels following D-Glucose consumption was 20%, where it was twice lower (9.75%) following natural honey consumption. Another similar related study also showed that honey supplementation in healthy subjects resulted in lower serum glucose concentrations and glycemic response than the value provided by honey-comparable glucose-fructose solutions. In other research studies, honey have shown beneficial effects on glucose-regulating hormones and pancreas, renal and hepatic functions, lipid metabolism as well as other important metabolic biochemical parameters.

In order to avoid the negative heat of dissolution and bitter aftertaste of Erythritol, several patents have been proposed such as United States Patent Application Publication, US 2013/0059030 A1, where a sweetener composition comprising a milled mixture having a particular size of 5 microns to about 100 microns of a carbohydrate and a high intensity sweetener, wherein the high intensity sweetener is present in an amount of from about 0.10 Wt. %, to about 50.0 Wt. % of the milled mixture. By doing this type of procedure, the bitter off taste of the milled mixture is reduced compared to a non-milled mixture having a particle size of greater than about 190 microns of the carbohydrate and the high intensity sweetener, and where the concentration of the high intensity sweetener is present in an amount from about 0.10 Wt. % to about 50.0 Wt. % of the non-milled mixture.

Another procedure for the formulation of a high potency sweetener is presented in U.S. Pat. No. 8,765,205 B2 whereby at least 0.001% of one sweetener consumable wherein that sweetener includes sucrose, fructose, glucose, high fructose corn syrups, corn syrups, xylose, arabinose, rhammose, xylitol, mannitol, sorbitol, inositol, acesulfame potassium, aspartame, neotame, sucralose, saccharine, or combinations thereof. For this case, at least one sweetener or sweetener combination is present in a concentration above the sweetness detection threshold in a concentration isosweet to 2% to 15% sucrose. The sweetener enhancer is instead present in a concentration near its sweetness detection threshold, wherein for stevioside, this concentration is from 2 to 60 ppm and wherein for rebaudioside A, this concentration is from 1 to 30 ppm.

A low-calorie sweetener composition is described in Patent Application US 2014/0255580 A1 and related with the use of combinations of Erythritol, Xylitol and Stevia. A special high-calcium, sugar-free type healthy sweetener for elderly people, is formulated using 10-20 percent of xylo-oligosaccharide, 10-30 percent of xylitol, 10-30 percent of L-Arabinose, 30-50 percent of isomalto-oligosaccharide and 0.1-5 percent of calcium lactate; putting the above materials into a mixed agitator for mixing, agitating for 10-20 minutes and finally packing the final mixture.

A sweetened consumable composition formulated using rebaudioside A and stevioside as sweetness enhancers compromise certain sweeteners and at least one sweetness enhancer in a concentration near its sweetness detection threshold is presented in U.S. Pat. No. 8,765,205 B2. The sweeteners include sucrose, fructose, glucose, high fructose corn syrup, corn syrup, xylose, arabinose, rhamnose, erythritol, xylitol, mannitol, sorbitol, inositol, acesulfame potassium, aspartame, neotame, sucralose, saccharine, or combinations thereof. The sweetness enhancer is selected from naringin dihydrochalcone, mogroside V, swingle extract, rubusoside, rubus extract, rebaudioside, and stevioside.

The creation of a mixture of Chromium and L-Arabinose is presented in European Patent EP 2429536 A1 as a method for decreasing the metabolization of sucrose in a host. By administering this composition to a host, a method for inhibiting the glycemic response to a meal containing sucrose in a host is reached, since studies have reported that different forms of chromium may provide improved glucose control in humans.

A novel high potency sweetener isolated from the Chinese fruit Luo Han Guo, which is derived from Siraitia grosvenorii (Swingle) C. Jeffery (Curcubitaceae, formerly called Momordica grosvenori), a plant growing mainly in Guangxi province in China is presented in US Patent Application US 20140170286 A1.

A sweetener composition is presented in European Patent 2112892 A1, comprising an extract of a fruit from the Cucurbitaceae family, at least one sugar alcohol, and a component selected from at least one salt of a monocarboxylic acid and/or at least one salt of a dicarboxylic acid, at least one of an alkali metal cation and/or an alkaline earth metal cation or combinations thereof.

Sweetener compositions can also be presented in the form of an ondansetron solid orally disintegrating dosage form, for oral administration as described in U.S. Pat. No. 7,390,503 B1. The formulation is made by at least one first water-dispersible component or water-insoluble cellulose derivative, ondansetron in a concentration of about 1 to about 10% by weight of said dosage form; mannitol in a concentration of about 1% to about 60% by weight of said dosage form. The formulation contains also xylitol in a concentration of about 1% to about 20% by weight of said dosage form, crospovidone in a concentration of about 1% to about 40% by weight of said dosage form, microcrystalline cellulose in a concentration of about 1% to about 10% by weight of said dosage form and a hydrophobic lubricant in a concentration of up to about 10% by weight of said dosage form.

A low glycemic sweetener comprising fructose and glucose oligosaccharide is presented in WO Patent 2005089483 A2, describing a process for producing a low glycemic sweetener, comprising reacting sucrose, an acceptor, and a glucan sucrose enzyme. A number of interesting sweetener formulations are presented in the form of a microencapsulated and granular form. Such is the case for WO Patent 1992011084 A1, describing a procedure whereby natural and artificial sweeteners, including Aspartame, are encapsulated in a protective shell material. This new form will enable the sweetener to resist the temperature, moisture, and pH effects presented during the baking process of cookies, pies, cakes, crackers, puddings, microwave treated foods, and any other food to which the sensitive natural or artificial sweetener is to be added, which will then be subjected to heating. The encapsulation process and materials mentioned in this application enable the survival of the sweeteners' sweetness through the baking cycle.

Another similar process for the production of a microencapsulated high intensity sweetening agent having a prolonged sweetness is presented in U.S. Pat. No. 5,108,763 A. (1992). The patent describes a formulation made by combining (a) a solution of a high intensity sweetening agent, (b) a polyvinyl acetate present having a molecular weight in the range from about 2,000 to about 100,000, (c) a plasticizing agent (d) a waxy material and (e) an emulsifying agent and combining them in a granular final form. A process for the production of a multiple encapsulated sweetener is presented as an encapsulated delivery system, which comprises a first high intensity sweetener encapsulated in a first core coating, followed by a second outer hydrophilic coating containing up to the solubility limit of the second coating of a second sweetener.

A process for the compaction and granulation of individual or combined sweet glycosides from a Stevia rebaudiana Bertoni plant extract is presented in European Patent EP 2498625 A1. This process particularly describes a procedure for making a substantially dust-free granulated sweetener which may contain Stevia sweeteners with or without other co-ingredients comprising such as Aspartame and Acesulfame-K, wherein the amount of the Acesulfame-K is 5 to 90% by weight based on the total amount of both the components and wherein the maximum particle size of the granules is about 1,400 μm or less.

In view of the importance of fructo-oligosaccharides such as Inulin and fibers of Yacón powder, a number of sweeteners and low glycemic compositions have been proposed utilizing these natural products. Such is the case of US Patent Application 20080299258 A1, presenting a natural prebiotic syrup concentrate with levels of inulin in the range of 30% to 99.7% by weight.

A sweetener composition comprising the polyol and agave syrup solids added in solid form during the manufacture of the food product is proposed in US Patent Application 20080268109 A1. In order to minimize the likelihood that the sweetener composition will cause the food product to function as a laxative, the sweetener composition includes proportions of agave and the polyol. The resulting delivery system may be incorporated into a variety of comestible products including chewing gums and other confections, baked goods, oral pharmaceuticals and oral hygiene preparations. A natural sugar replacement is proposed in US Patent Application US 20100015320 A1, comprising Stevia extract and at least one additive selected from the group comprising fructo-oligosaccharides, fructose, magnesium carbonate, and combinations thereof.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIGS. 1A and 1B are a chart and tabular data associated with a sweetener composition made according to the method of the present application.

FIGS. 2A and 2B are a chart and tabular data associated with an alternative sweetener composition made according to the method of the present application.

FIG. 3 is chart showing the results of an in vivo study on test subjects consuming a test beverage to measure postprandial glucose responses to Sucrose Control, Sucralose, and Healthy Sweet.

FIG. 4 is a chart showing the results of an in vivo study on test subjects consuming a test beverage to measure Glucose IAUC response to Sucrose Control, Sucralose, and Healthy Sweet.

FIG. 5 is a chart showing Postprandial insulin responses to Sucrose Control, Sucralose and healthy Sweet beverages using the method for the sweetener compositions of FIGS. 1 and 2.

FIG. 6 is a chart presenting the Serum insulin increment area under the curve of Sucrose Control, Sucralose, and Healthy Sweet beverage.

FIG. 7 is a chart showing the Mean symptom score (mm) for Bloating (at 0 min, 120 min) after the Sucrose control, Sucralose, and Healthy Sweet beverage.

FIG. 8 is a chart showing Mean symptom score (mm) for Flatulence (at 0 min, 120 min) after the Sucrose control, Sucralose, and Healthy Sweet beverage.

FIG. 9 is a chart of the process of making the sweetener composition of the present application.

FIG. 10 is a chart of the ingredients within the various sweetener compositions of the present application.

While the device and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation may be described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

The device and method in accordance with the present application overcomes one or more of the above-discussed problems. The following drawings, either in the form of graphs and tables, form part of the present speciation and are included to further illustrate certain aspects of the invention. The invention can be better understood by reference to one or more of the drawings in combination with the detailed description of the specific embodiments presented herein.

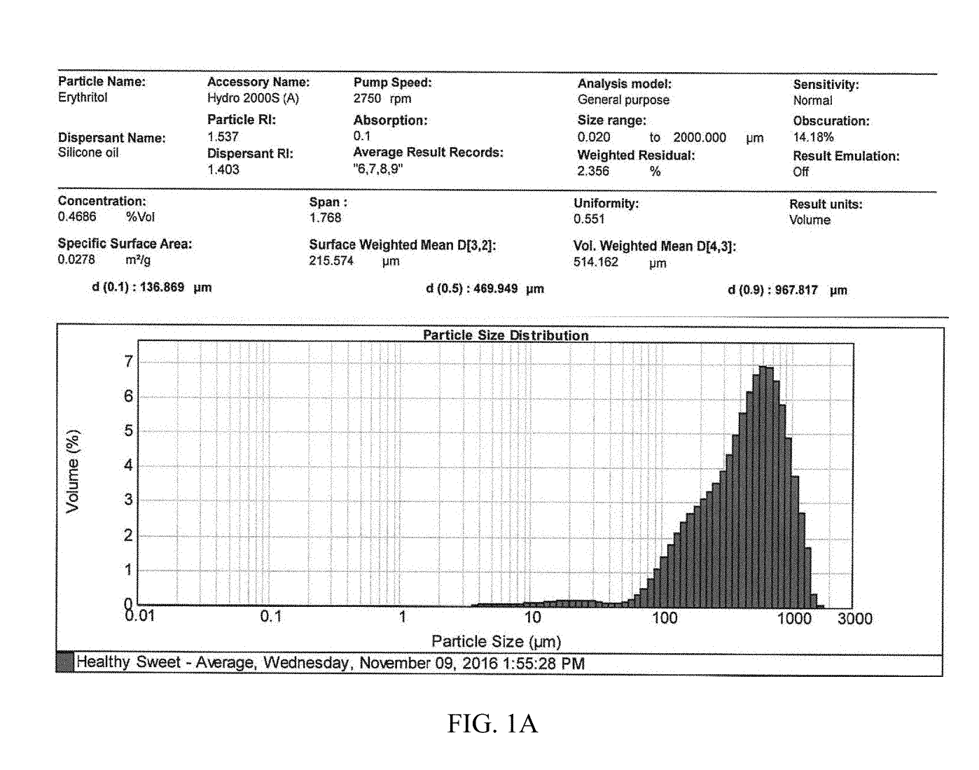

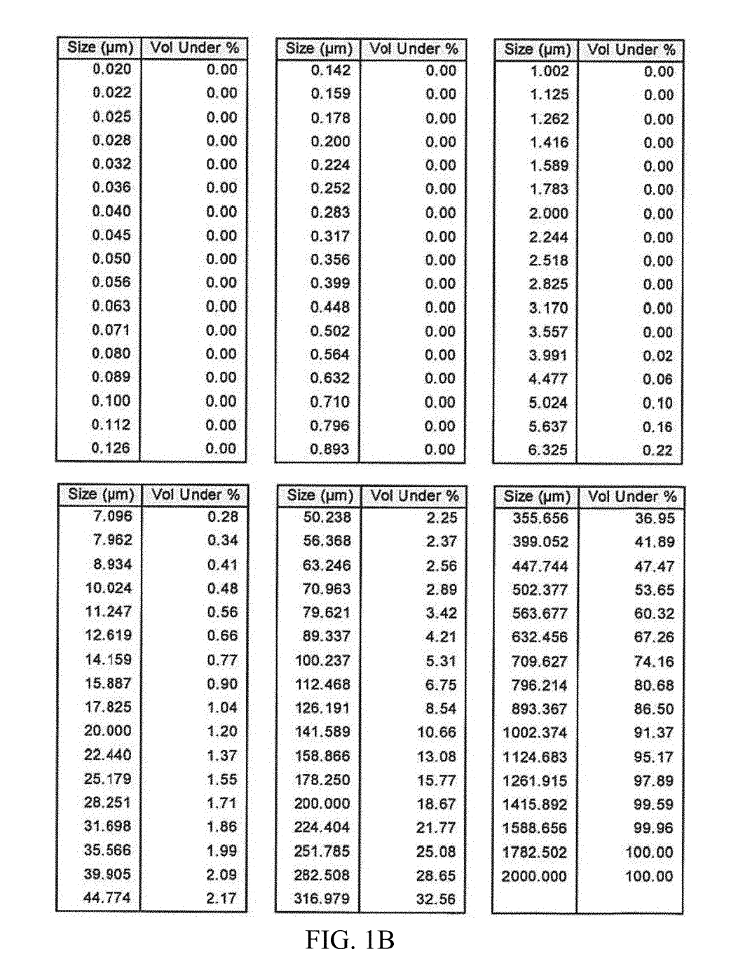

FIG. 1 shows the average particle size distribution of the raw materials for the manufacturing of the sweetener, prior the process of granulation and composed mainly by a mixture of Erythritol 85% w/w and 15% L-Arabinose w/w. In Figure One, we can appreciate the particle size distribution of the mixture where 10% of the total volume presents less than 136.869 microns, 50% of the total volume presents less than 469.949 microns and 90% of the total volume present less than 987.817 microns.

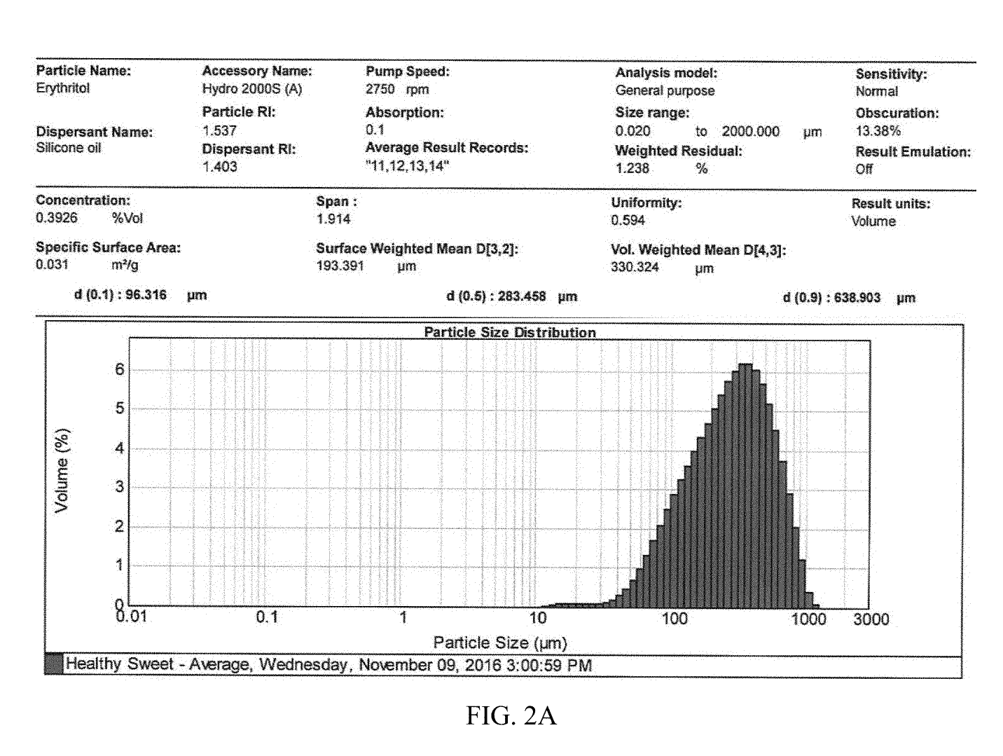

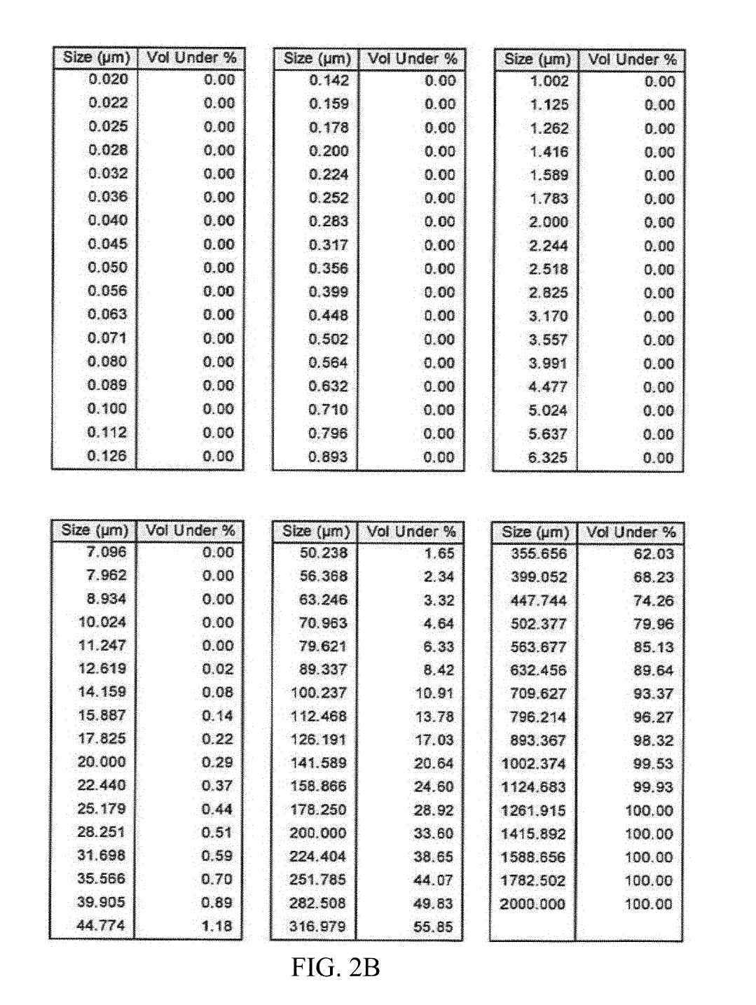

FIG. 2 presents the particle size distribution for the encapsulated material which is formulated by a mixture of Erythritol 85% w/w, L-Arabinose 15% w/w, and granulated using a 5% w/w total weight of the final mixture of a gel syrup mixture composed by Glycerin and Trehalose in a 1:1 ratio. As we may appreciate by looking the results in Figure Two, we now have a more uniform particle distribution, showing a more defined dome distribution of particles. This time, 10% of particles are less than 96.316 microns, 50% by particles less than 283.458 microns and 90% by particles less than 638.903 microns. That is, at the mark of 50% of volume particles, Figure Two shows a 39.69% reduction of particles while at the 90% volume, the decrease is instead of 33.99%. These results show how the process of granulation clearly changed the initial particle size distribution of particles from the initial mixture of Erythritol-L-Arabinose.

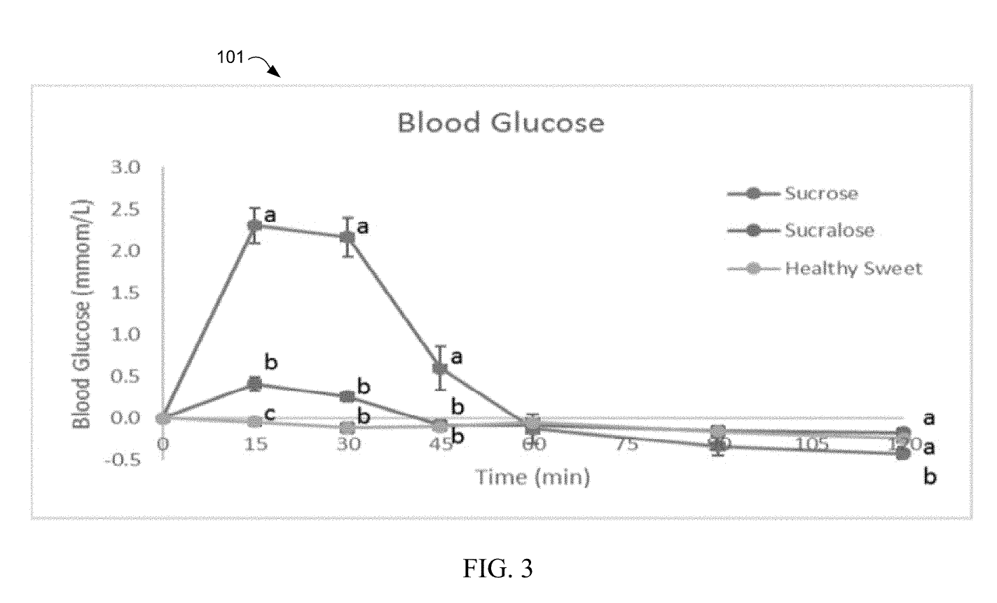

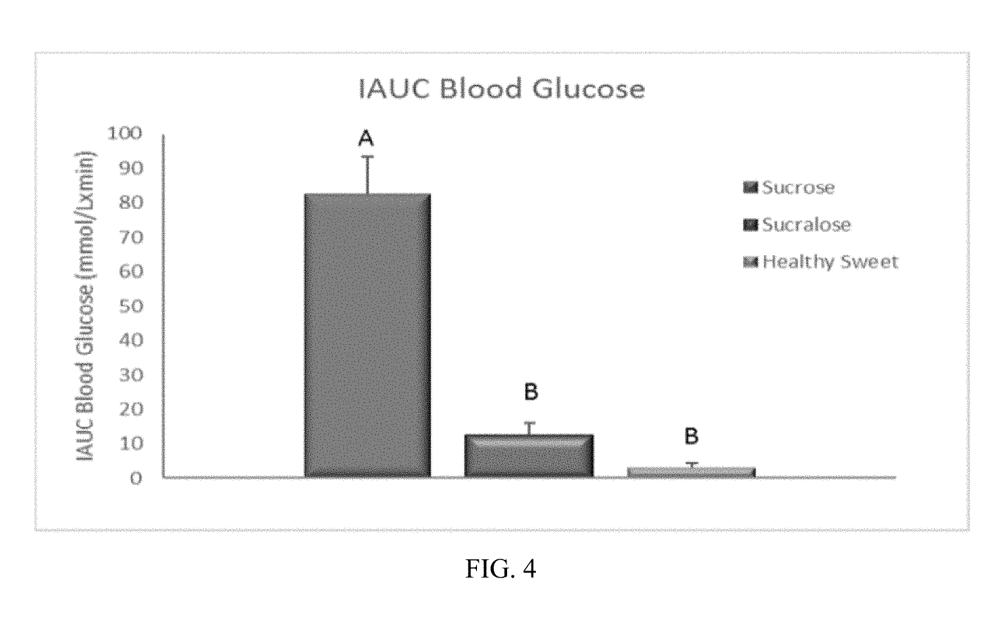

FIGS. 3 and 4 represent the outcome of an in vivo study performed using 15 previously selected people. Selected subjects arrived at the labs between 8 am and 9:45 am, and the start time for each subject was kept as similar as possible. After being weighed, 2 fasting blood samples at 5 min intervals were collected; subjects started to consume a test beverage (sweetener mixed with water) which was consumed in its entirety within 5 min. A timer was started at the first sip of the beverage, and further capillary blood samples were obtained at t=15, 30, 45, 60, 90 and 120±2 min, for the determination of glucose and insulin concentrations. Blood samples were collected into 2 separate vials: one (2-3 drops blood) for glucose analysis and the other (8-10 drops of blood) for insulin. Before and during the test, a blood glucose test record was filled out with the subject's initials, ID number, date, body weight, test meal, time of starting to eat, time it took to eat, time and composition of last meal, and any unusual activities. At the beginning and end, participants were asked to fill out a symptom questionnaire. During the 2 hours of the test, participants remain seated quietly.

After the last blood sample was obtained participants were offered a snack and allowed to leave. The tested foods consisted of three of the following isovolumetric products: 25 g sucrose control, 2.5 g of sucralose (i.e. Splenda®, McNeil Consumer Healthcare, Markham, Canada) and 25 g of the granulated sweetener Healthy Sweet blend dissolved each in 400 ml water. The sucrose test meal acted as the positive control and the sucralose as the negative control and the amount used was chosen to match the levels of sweetness in the other two test meals. Test meals were administered in a randomized order. FIG. 3 shows the postprandial glucose responses to Sucrose control, Sucralose, and Healthy Sweet beverage. The results were expressed as mean±sem, Abc being time points with different letters which were statistically significantly different (p<0.004). FIG. 4 shows the increment area under the curve for blood glucose relative to Sucrose Control, Sucralose, and Healthy Sweet beverage. The data was expressed as mean±sem and ABC bars with a different letter were statistically significantly different (p<0.00001).

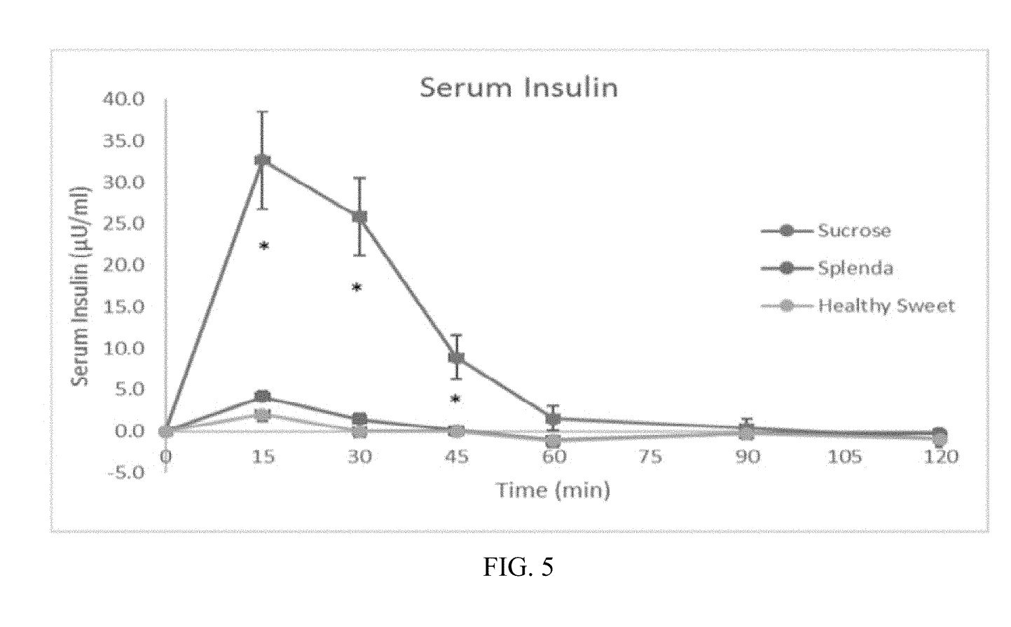

FIG. 5 shows the postprandial insulin responses to Sucrose Control, Sucralose, and Healthy Sweet beverages, and data was expressed as mean±sem, showing that sucralose and Healthy Sweet were significantly lower than sucrose (p=0.0001).

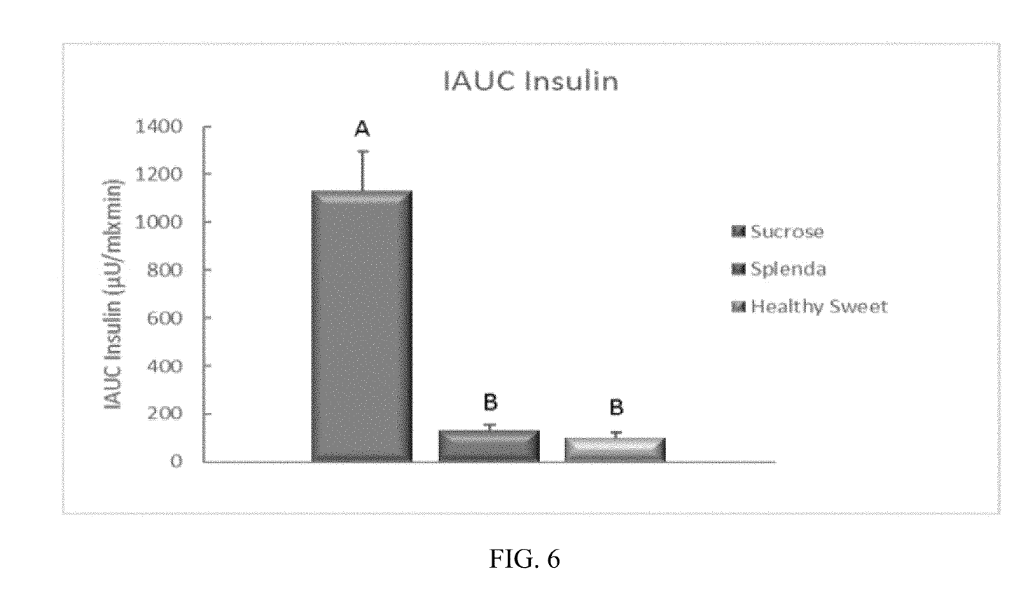

FIG. 6 presents the Serum insulin increment area under the curve of Sucrose Control, Sucralose, and Healthy Sweet beverage, where data was expressed as mean±sem and ABC bars with a different letter were also statistically significantly different (p<0.00001).

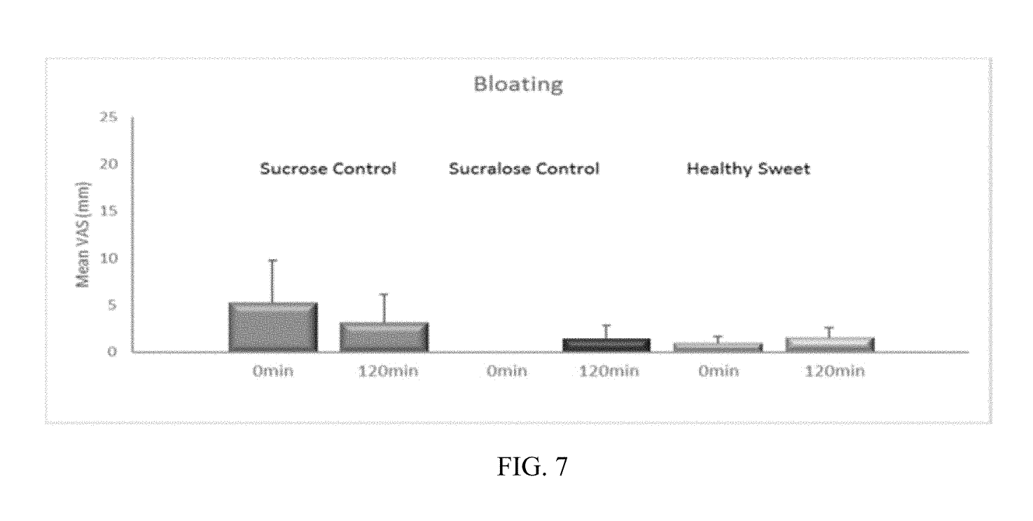

FIG. 7 presents the mean symptom score (mm) for Bloating at 0 min, 120 min) after the Sucrose control, Sucralose, and Healthy Sweet, and the data was presented as mean±sem.

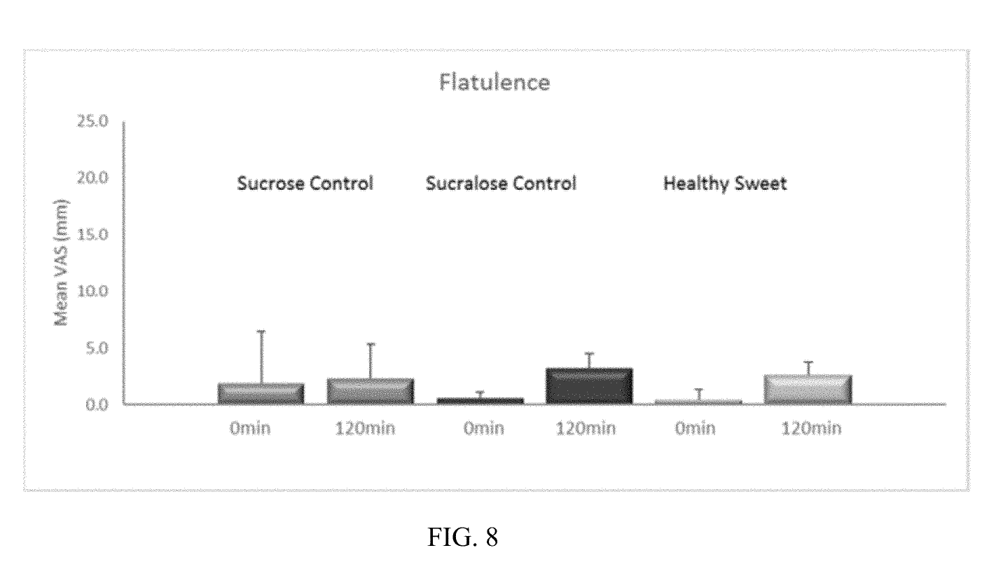

Finally, FIG. 8 illustrates the mean symptom score (mm) for flatulence at 0 min, 120 min) after the Sucrose control, Sucralose control and Healthy Sweet, and data was presented as mean±sem. As we can appreciate from these results, unlike the Sucrose control, Healthy Sweet did not raise postprandial glucose or insulin levels after ingestion. When Healthy Sweet was compared to the non-caloric sweetener, sucralose, postprandial glucose, and insulin levels either were lowered or did not differ significantly from the response after sucralose ingestion. There were no differences in palatability or physical comfort scores between the meals. This study therefore demonstrates that Healthy Sweet is a palatable sweetener that does not raise postprandial glucose or insulin levels after ingestion or cause any GI side effects.

In view of the nutritional benefits early mentioned on the use of Erythritol, L-Arabinose, Trehalose, and Glycerin, Yacón and Honey, applicant proposed the formulation of a sweetener composition based on these six substances, with some minor variations. These variations are the inclusion of non-alcoholic vanilla extract into the glycerin-trehalose syrup, the honey-trehalose syrup and the optional addition of Yacón power into the initial mix of Erythritol and L-Arabinose. Applicant proposed that a way to resolve the problem of Erythritol off-taste and increase sweetness, is by creating a syrup which after its addition to the initial mixture of Erythritol-L-Arabinose, it will produce a granular material having a greater sweetness, a well defined pleasant flavor pleasant flavor as well as a low calorie content. For this purpose two major syrups were formulated; one composed by glycerine, trehalose and vanilla glycerin extract a second one made using honey, trehalose and vanilla glycerin extract. Edulcurant syrups made by mixing glycerin and Erythritol can be made quite easily but tend to crystallize upon cooling. Applicant found that when a mixture of glycerin and trehalose, having a ratio of 0.8:1, or 1:1 are mixed and then heated for a period of 10 minutes at a temperature below 80 degrees C., the final syrup remains stable without crystallization at room temperature and has a very pleasant, sweet flavor. The same happens when honey and trehalose are combined in ratios of honey:trehalose of 3.8:1 to 4:0.8, and subjected to heat for a period of 10 minutes at a temperature below 80 degrees C., then the final syrup remains stable without crystallization at room temperature and has a very pleasant, sweet flavor. This behavior could be understood by considering the concept of glass transition temperature (Tg), which is known as the temperature above which transition from viscous to fluid state occurs and the components acquire greater mobility. This property can be considered the reason which characterizes the unusual effect exhibited by trehalose capable of melting in the presence of other sugars and carbohydrates and also to undergo cooling to room temperature, but without undergoing crystallization. This transition to the glassy state or the vitrification theory is put forward as the most widely accepted hypothesis to explain the bioprotective action of trehalose. Glasses typically exhibit very high viscosities, with the result that the associated melted substances remains encapsulated within a glassy matrix, and for all practical purposes, remain stable. That may be the reason, especially in this binary system glycerin-trehalose, that this disaccharide remains free from recrystallization after reaching room temperature.

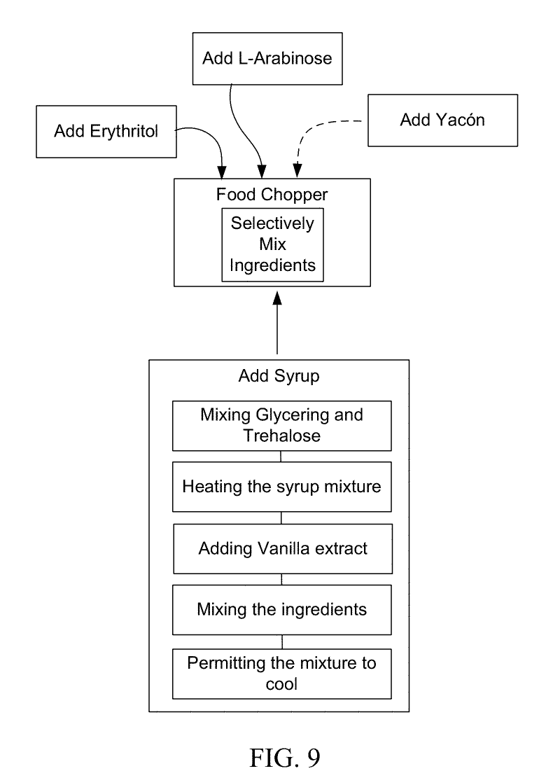

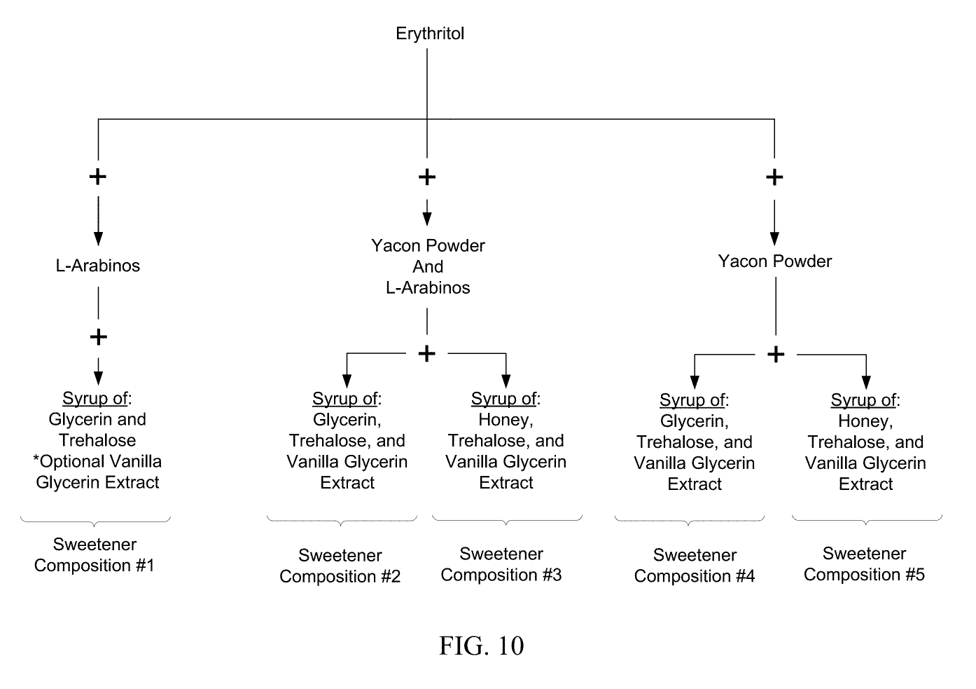

Regarding the preparation of the Edulcurant composition (sweetener compositions), a number of examples will be provided to illustrate such a process as seen also through the use of FIGS. 9 and 10 in the drawings. First, discussion is had wherein preparation is done at Laboratory Scale using Erythritol-L-Arabinose using syrups made by the combination of Glycerin-Trehalose-vanilla glycerin extract and Honey-Trehalose-Vanilla glycerin extract. It should be understood that the description of the precise types and/or capacities of various equipment used may be varied as long as the capability of the equipment facilitates the same functions and results.

### Example One: System Composed by Erythritol, L-Arabinose, Glycerin, Trehalose

In a 3.5 Cup Food Chopper equipment the following materials are placed; From 100 to 180 grams of Erythritol, preferably 170 grams, are added into the plastic chamber of the chopper followed by from 20 to 90 grams, preferably 30 grams, of L-Arabinose. The system is run two times at the maximum set speed for 30 seconds in the food chopper equipment. In the meantime, the following syrup is formulated and made as follows: From 1 to 15 grams, preferably 8 grams, of vegetable glycerin are added into a beaker of 100 mL followed by from 1 to 15 grams, preferably 10 grams, of Trehalose. Next, the system is heated to 70-80 degrees Celsius, in order to mix and melt the sugars together, which occurs after 8 to 10 minutes of heating. Once the mixture reached room temperature, from 2 to 20 grams, preferably 10 grams, of the glycerin-trehalose syrup are added into the chopper in two portions of 5 grams each and allowed to mix with the rest of the initial Erythritol-L-Arabinose mixture. After every addition of the 5 grams of the glycerin-trehalose syrup, three mixing action of 30 seconds each are made until a granulated mixture is formed. In order to ensure proper homogeneous mixing, a final grinding of three mixing cycles of 10 seconds each, are made using a domestic Krups one touch pulverizer. The final mixture is a granular flowing powder, having pleasant flavor.

### Example Two: System Composed by Yacón Powder, Erythritol, L-Arabinose, Glycerin, Trehalose, and Vanilla Glycerin Extract

In a 3.5 Cup Food Chopper equipment the following materials are placed; From 100 to 180 grams of Erythritol, preferably 160 grams, are added into the plastic chamber of the chopper followed by 10 grams of Yacón powder made from the plant (Smallanthus sonchifolius). Immediately after, the mixture is mixed and sheered for two time cycles of one minute each, followed by the addition from 20 to 90 grams, preferably 30 grams, of L-Arabinose. The system is run two times at the maximum set speed for 30 seconds in the food chopper equipment. In the meantime, the following syrup is formulated and made as follows: From 1 to 35 grams, preferably 32 grams, of vegetable glycerin are added into a beaker of 100 mL followed by from 1 to 45 grams, preferably 40 grams, of Trehalose. Next, the system is heated to 70-80 degrees Celsius, in order to mix and melt the sugars together, which occurs after 8 to 10 minutes of heating. Once the mixture reached a temperature from 55 to 60 degrees C., 8 grams of glycerin vanilla extract were added, mixed, and allowed to reach room temperature. At this point a total of 40 grams of the glycerin-trehalose-vanilla syrup were added, in four portions of 10 grams each, into the chopper and allowed to mix with the rest of the Yacón-Erythritol-L-Arabinose mixture. After every addition of the 10 grams portions of the glycerin-trehalose-vanilla syrup, three mixing action of 30 seconds each are made until a granulated mixture is formed. In order to ensure proper homogeneous mixing, a final grinding of three mixing cycles of 10 seconds each are made using a domestic Krups one touch pulverizer. The final mixture is a granular flowing powder, having pleasant flavor.

### Example Three: System Composed by Yacón Powder, Erythritol, L-Arabinose, Honey, Trehalose, and Vanilla Glycerin Extract

In a 3.5 Cup Food Chopper equipment the following materials are placed; From 100 to 180 grams of Erythritol, preferably 160 grams, are added into the plastic chamber of the chopper followed by 10 grams of Yacón powder made from the plant (Smallanthus sonchifolius). Immediately after, the mixture is mixed and sheered for two time cycles of one minute each, followed by the addition from 20 to 90 grams, preferably 30 grams, of L-Arabinose. In the meantime, the following syrup is formulated and made as follows: From 1 to 45 grams, preferably 40 grams, of Honey are added into a beaker of 100 mL followed by from 1 to 15 grams, preferably 8 grams, of Trehalose. Next, the system is heated to 70-80 degrees Celsius, in order to mix and melt the sugars together, which occurs after 8 to 10 minutes of heating. Once the mixture reached a temperature from 55 to 60 degrees C., 2 grams of glycerin vanilla extract were added, mixed, and allowed to reach room temperature. At this point a total of 40 grams of the Honey-trehalose-vanilla syrup were added, in four portions of 10 grams each, into the chopper and allowed to mix with the rest of the Yacón-Erythritol-L-Arabinose mixture. After every addition of the 10 grams of the Honey-Trehalose-vanilla syrup, three mixing action of 30 seconds each are made until a granulated mixture is formed. In order to ensure proper homogeneous mixing, a final grinding of three mixing cycles of 10 seconds each are made using a domestic Krups one touch pulverizer. The final mixture is a granular flowing powder, having pleasant flavor.

### Example Four: System Composed by Yacón Powder, Erythritol, Glycerin, Trehalose, and Vanilla Glycerin Extract

In a 3.5 Cup Food Chopper equipment the following materials are placed; From 100 to 180 grams of Erythritol, preferably 190 grams, are added into the plastic chamber of the chopper followed by 10 grams of Yacón powder made from the plant (Smallanthus sonchifolius). Immediately after, the mixture is mixed and sheered for two time cycles of one minute each. In the meantime, the following syrup is formulated and made as follows: From 1 to 35 grams, preferably 32 grams, of vegetable glycerin are added into a beaker of 100 mL followed by from 1 to 45 grams, preferably 40 grams, of Trehalose. Next, the system is heated to 70-80 degrees Celsius, in order to mix and melt the sugars together, which occurs after 8 to 10 minutes of heating. Once the mixture reached a temperature from 55 to 60 degrees C., 8 grams of glycerin vanilla extract were added, mixed, and allowed to reach room temperature. At this point a total of 40 grams of the glycerin-trehalose-vanilla syrup were added, in four portions of 10 grams each, into the chopper and allowed to mix with the rest of the Erythritol-L-Arabinose mixture. After every addition of the 10 grams of the glycerin-trehalose-vanilla syrup, three mixing action of 30 seconds each are made until a granulated mixture is formed. In order to ensure proper homogeneous mixing, a final grinding of three mixing cycles of 10 seconds each are made using a domestic Krups one touch pulverizer. The final mixture is a granular flowing powder, having pleasant flavor.

### Example Five: System Composed by Yacón Powder, Erythritol, Honey, Trehalose and Vanilla Glycerin Extract

In a 3.5 Cup Food Chopper equipment the following materials are placed; From 100 to 200 grams of Erythritol, preferably 190 grams, are added into the plastic chamber of the chopper followed by 10 grams of Yacón powder made from the plant (Smallanthus sonchifolius). Immediately after, the mixture is mixed and sheered for two time cycles of one minute each. In the meantime, the following syrup is formulated and made as follows: From 1 to 45 grams, preferably 40 grams, of Honey are added into a beaker of 100 mL followed by from 1 to 15 grams, preferably 8 grams of Trehalose. Next, the system is heated to 70-80 degrees Celsius, in order to mix and melt the sugars together, which occurs after 8 to 10 minutes of heating. Once the mixture reached a temperature from 55 to 60 degrees C., 2 grams of glycerin vanilla extract were added, mixed, and allowed to reach room temperature. At this point a total of 40 grams of the honey-trehalose-vanilla syrup were added, in four portions of 10 grams, each, into the chopper and allowed to mix with the rest of the Yacón-Erythritol mixture. After every addition of the honey-trehalose-vanilla syrup, four mixing action of 30 seconds each are made until a granulated mixture is formed. In order to ensure proper homogeneous mixing, a final grinding of three mixing cycles of 10 seconds each are made using a domestic Krups one touch pulverizer. The final mixture is a granular flowing powder, having pleasant flavor.

### Example Six

Discussion is now given wherein preparation is done industrially using the system composed by Yacón-Erythritol-L-Arabinose mix followed by the addition of the Honey-trehalose-vanilla mixture.

In an industrial high intensity mixer having a nominal capacity of 110 Kilograms; 70 liters of tap water are introduced and the system is heated up to 90 degrees Celsius for 5 minutes. At the end of the sterilization process, the heated liquid water is discharged and the unit dried using compressed air. At time 0, while having an internal temperature of 30 degrees Celsius, and a temperature in the outside jacket of 30 degrees Celsius, the unit is charged with a mixture composed by the following food ingredients: 12 kilograms of Erythritol and 0.75 kilograms of Yacón powder which are mixed at low speed for 3 minutes. The inner temperature of the reactor dropped at 27 degrees Celsius, and at this time, the inner mixing of the reactor along with the axial internal chopper are placed at 85% of its maximum capacity in order to mix and reduce particle size for a period of 5 minutes. After these initial 5 minutes of intense mixing of the Erythritol-Yacón mixture in the plug share unit (running at 85% of max velocity), the mixing intensity is reduced to half, and at this point 2.25 kilograms of L-Arabinose are introduced into the reactor and mixed at low speed for 3 minutes. The inner temperature of the reactor dropped at 27 degrees Celsius, and at this time, the inner mixing of the reaction along with the one of the axial internal chopper are placed at 80% of its maximum capacity in order to mix and reduce particle size for 5 minutes. In the meantime, in a 5-liter stainless steel container nominal capacity, 2400 grams of honey are combined with 480 grams of Trehalose. The sugars are mixed and then the mixture is heated until all the sugars are melted (temperature between 70-80 degrees Celsius for 10 minutes), and when the temperature dropped to 50 degrees Celsius, 120 grams of alcohol and sugar free glycerin vanilla extract are introduced, mixed and then the whole mixture is allowed to reach room temperature. After the first initial 5 minutes of mixing of the final Erythritol-Yacón-L-Arabinose mixture in the plug share unit (running at 80% of max velocity), the mixing intensity is reduced to half, and at this point, 0.75 kilograms of the Honey-trehalose-vanilla extract, are introduced into the reactor, allowed to mix for 5 minutes having the high intensity chopper at 85% of its maximum velocity while maintaining the inner temperature of the mixing unit at 40 degrees Celsius for another 5 minutes. The same operation is repeated three more times until a total of 3 kilograms of the Honey-trehalose-vanilla extract are introduced, mixed and finalized. At this point, the system's speed is reduced again at one-half of its initial mixing speed, and cool tap water is introduced into the jacket of the equipment while the mixing is continued for another 5 minutes. At the end of this time, the mixing is stopped and the product discharged out of the reactor. A total of 18.3 6 kilograms of the sugar mixture is produced as a homogenous free flowing granulate powder.

These processes can be shown in an exemplary application. For example, in the production of chocolate spread using Edulcurant product mixture made from Example Two.

A total of 130 grams of hazelnuts previously pealed, grounded, and heated at 80 degrees Celsius for 5 minutes, are placed inside of a domestic blender type Vitamix model 5300, along with an oil mixture composed by (0.3 grams of Soya lecithin, 55 grams of Walnut oil, and 40 grams of melted deodorized Coconut Oil). The mixture is then mixed at a speed (knob set on 5) for 5 minutes. At the end of this first time mix, a mixture of 130 grams of the mixture described and made in example 3 is added, along with 2 grams of a glycerin extract containing 20% of glycyrrhizic acid and mixed at the same intensity (knob set on 5) for another 5 minutes. While mixing, a mixture composed of 10 grams of dry fat-free milk powder and 35 grams of Organic Cocoa Powder are added and mixed at the same intensity (knob set on 5) for another 5 minutes. Lastly, ¼ spoon of Organic Vanilla extract are added, mixed for 3 minutes, and finally 0.5 grams of salt are added and mixed for another 3 minutes. The final material has the rheological consistency of a chocolate spread and a very good flavor.

The current application has many advantages over the prior art as noted throughout the description. The particular embodiments disclosed above are illustrative only and are not intended to be exhaustive or to limit the invention to the precise form disclosed, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A method of making a sweetener composition, comprising:
blending a mixture of Erythritol and L-Arabinose;
adding a syrup composed of trehalose; and
incorporating the syrup to the initial blended mixture under the action of a high intensity mixer, thus producing a granular free flowing powder;
wherein the amount of Erythritol varies from 50 to 95 Wt. % and the amount of L-Arabinose varies from 5 to 40 Wt. %, such that the bitter off-taste of the Erythritol is reduced by incorporating L-Arabinose and a specific amount of the syrup, which is incorporated into the initial mixture of Erythritol-L-Arabinose under intense shear mixing, creating a final granulated free flowing mixture.

2. The method of claim 1, wherein the syrup includes a specific amount of glycerin.

3. The method of claim 2, wherein the glycerin-trehalose syrup is made by mixing vegetable glycerin and Trehalose in a ratio which may vary from 0.8:1 to 1:1, where the mixture is heated to a temperature of 70 to 80 degrees Celsius for a considerable time enough until all solids are dissolve and then the mixture is allowed to cool to room temperature prior its use.

4. The method of claim 2, wherein the amount of glycerin-trehalose syrup which is added to the Erythritol-L-Arabinose initial mixture varies from 1 to 35 Wt. %, and preferably from 2 to 20 Wt. % of the final mixture.

5. The method of claim 1, wherein the syrup also includes a vanilla glycerin extract in an amount which varies from 3 to 35 Wt. %, and preferably from 3 to 20 Wt. % of the final mixture.

6. The method of claim 1, wherein the initial Erythritol-L-Arabinose mixture further includes a natural fiber of Yacón powder made from the plant (Smallanthus sonchifolius) in a quantity which varies from 0.3 to 20 Wt. %, preferably 2 to 15 Wt. % of the final Erythritol-L-Arabinose mixture.

7. The method of claim 1, further including a mixture composed of Yacón powder made from the plant Smallanthus sonchifolius and Erythritol; wherein the amount of Yacón powder varies from 1 to 20 Wt. % and the amount of Erythritol varies from 85 to 97 Wt. %, and where a specific amount of a syrup made from a combination of ingredients including glycerin-trehalose-vanilla extract, is incorporated into the initial mixture of Yacón powder-Erythritol in a quantity which varies from 3 to 20 Wt. %, under intense shear mixing, creating a final granulated free flowing mixture.

8. The method of claim 1, further including a mixture composed of Yacón powder made from the plant Smallanthus sonchifolius and Erythritol; wherein the amount of Yacón powder varies from 1 to 20 Wt. % and the amount of Erythritol varies from 85 to 97 Wt. %, and where a specific amount of a syrup made from a combination of ingredients including honey-trehalose-vanilla extract, is incorporated into the initial mixture of Yacón powder-Erythritol in a quantity which varies from 3 to 20 Wt. %, under intense shear mixing, creating a final granulated free flowing mixture.

9. The method of claim 1, wherein the final granulated mixture has an approximate average particle size where 50% of particles are less than 283.458 microns and 90% by particles, which are approximately less than 638.903 microns.

10. The method of claim 1, wherein the main carbohydrates are a polyol selected from the group consisting of Erythritol and vegetable glycerin, the pentose L-Arabinose, the non-reducing disaccharide trehalose, and natural fiber from the Yacón powder made from the plant Smallanthus sonchifolius.

11. The method of claim 1, wherein the mixture is created by blending a portion of the Erythritol, the L-Arabinose, and the syrup under the action of a high intensity mixer.

12. The method of claim 11, wherein the blending occurs after each new ingredient is introduced into the mixer.

13. The method of claim 11, wherein the blending occurs after all ingredients are introduced into the mixer.

14. The method of claim 1, wherein the syrup is formulated by the steps of:
creating a mixture of glycerin and trehalose; and
heating the syrup mixture sufficiently to mix and melt the sugars together.

15. The method of claim 14, wherein the syrup further includes:
adding a vanilla extract to the syrup mixture when the syrup mixture is in a heated condition;
mixing the vanilla extract and the syrup mixture; and
allowing the vanilla extract and syrup mixture to reach room temperature.

16. A method of making a sweetener composition, comprising:
blending a mixture of Erythritol and Yacón powder;
adding a syrup composed of trehalose and vanilla glycerin extract; and
incorporating the syrup to the initial blended mixture under the action of a high intensity mixer, thus producing a granular free flowing powder;
wherein the amount of Erythritol varies from 50 to 95 Wt. % and the amount of Yacón powder varies from 5 to 40 Wt. %, such that the bitter off-taste of the Erythritol is reduced by incorporating Yacón powder and a specific amount of the syrup, which is incorporated into the initial mixture of Erythritol-Yacón powder under intense shear mixing, creating a final granulated free flowing mixture.

17. The method of claim 16, wherein the syrup includes a specific amount of glycerin.

18. The method of claim 16, wherein the syrup includes a specific amount of honey.

19. The method of claim 16, wherein the syrup is formulated by the steps of:
creating a mixture of vanilla glycerin extract and trehalose; and
heating the syrup mixture sufficiently to mix and melt the sugars together.

20. The method of claim 19, wherein the syrup further includes:
adding at least one of a honey and a glycerin to the syrup mixture when the syrup mixture is in a heated condition;
mixing the at least one of the honey and the glycerin and the syrup mixture; and
allowing the syrup mixture to reach room temperature.
